(19) United States
(12) Patent Application Publication
(10) Pub. No.: US 2009/0038160 A1
(43) Pub. Date: Feb. 12, 2009

(54) LOCKING CASE

(76) Inventor: Joseph L. Pomerantz, Moorpark, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/836,372

(22) Filed: Aug. 9, 2007

(51) Int. Cl. B26B 1/08

(52) U.S. Cl. 30/162

(57) ABSTRACT

A utility knife includes a slidably retractable knife blade, which is moving into and out of the knife body by a sliding mechanism on the side of the body. The knife blade is held by a carrier and secured to the carrier by a two-pronged lever, where a shorter one of the prongs is moved within a slot in the knife blade to secure the blade. The blade is released by pressing the longer one of the prongs to move the shorter prong out of the slot. A light in the body is located below the knife blade to enable the user to illuminate a work area while using the knife.

### BACKGROUND

1. Field of Invention

The present invention relates generally to knives and in particular to utility knives.

2. Related Art

Utility knives typically are designed such that the blade folds into the body of the knife so that the knife can be carried or stored without risk of cutting the user. Throughout the years, many different features and designs have been used in utility knives. One typical feature is a slide mechanism for retracting and extending the knife blade. Such a slide mechanism is typically placed on the top of the knife and allows the user to push out or pull back the blade. However, these slide mechanisms may not enable the user to place the knife blade in different positions (i.e., locked either in a completely open or completely closed position). Another disadvantage is that a top sliding mechanism may not be convenient for some users due to placement.

Another feature of utility knives is the release mechanism for the blade to allow the user to replace the blade as needed. Many release mechanism designs require a screw, which would need the user to rotate the screw, such as with a screwdriver or by hand. This can be time-consuming and/or inconvenient.

Therefore, there is a need for a utility knife that overcomes the disadvantages of conventional utility knives discussed above.

### SUMMARY

According to one aspect of the invention, a utility knife has a slide mechanism on the side of the knife body, where the slide mechanism has at least two positions to lock the knife blade. In one embodiment, there are three positions. A thumb or finger control allows the user to slide the blade in or out and lock it into a desired position by simply placing the control into a pre-set slot along the longitudinal slide.

In another embodiment, a release mechanism for a sliding utility knife includes a two-pronged lever that releases the knife blade when pressed by the user and locks the knife blade when released. The lever has a taller prong and a shorter prong at the end of the lever. By pushing down on the taller prong, the shorter prong depresses sufficiently to allow the blade to be moved in and out of the holder. When the taller prong is released, tension in the lever brings both prongs up. As a result, if one or more grooves in the knife lines up with the shorter prong, the shorter prong positions itself within a groove to “lock” or secure the knife blade in the holder. Thus, this simple release mechanism enables the user to quickly and easily remove and replace the knife blade.

In another embodiment, the utility knife has a light, such as an LED, located beneath the knife blade, where the light is directed to a cutting area of the knife. Thus, when activated, the light allows the user to see the cutting area, providing advantages such as night time use and increased safety and accuracy in cutting. A pressure switch or button located on the bottom of the knife body activates the light when the switch is depressed and deactivates the light when the switch is released. The location of the switch enables the user to easily turn on the light when grasping the knife for use.

Due in part to one or more of these features, the utility knife of the present invention can be desirably more compact than conventional knives. For example, the utility knife can be shorter than conventional utility knives and may be up to 50% or more thinner than conventional knives.

These and other features and advantages of the present invention will be more readily apparent from the detailed description of the preferred embodiments set forth below taken in conjunction with the accompanying drawings.

### BRIEF DESCRIPTION OF THE DRAWINGS

FIG. 1 is an exploded view of a utility knife according to one embodiment of the present invention;

FIGS. 2A, 2B, 2C, and 2D are one side view, another side view, a bottom view, and an end view, respectively, of the utility knife of FIG. 1;

FIG. 3 is a perspective view of a blade release/lock mechanism according to one embodiment; and

FIG. 4 is a side view of a blade holder according to one embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

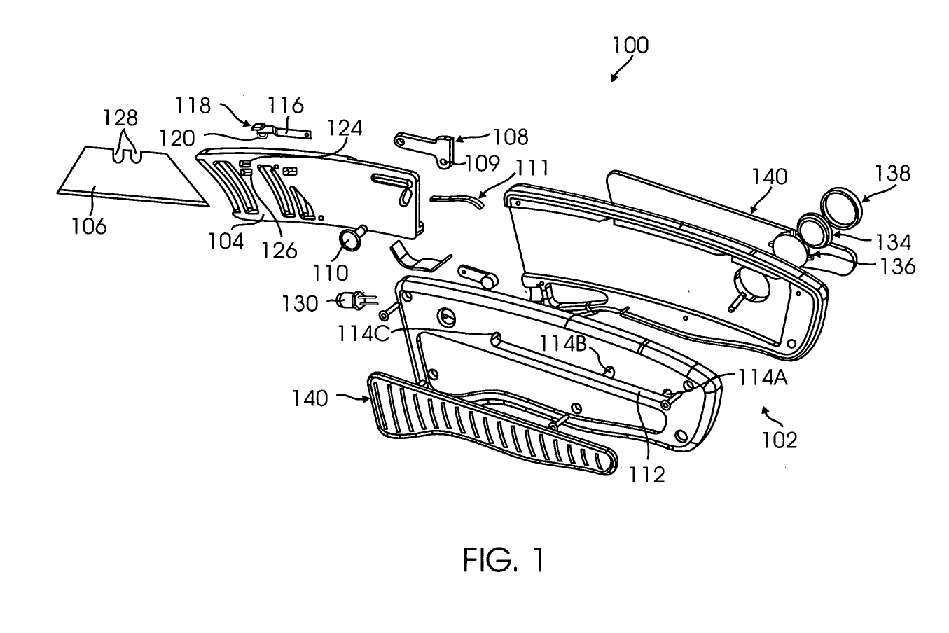

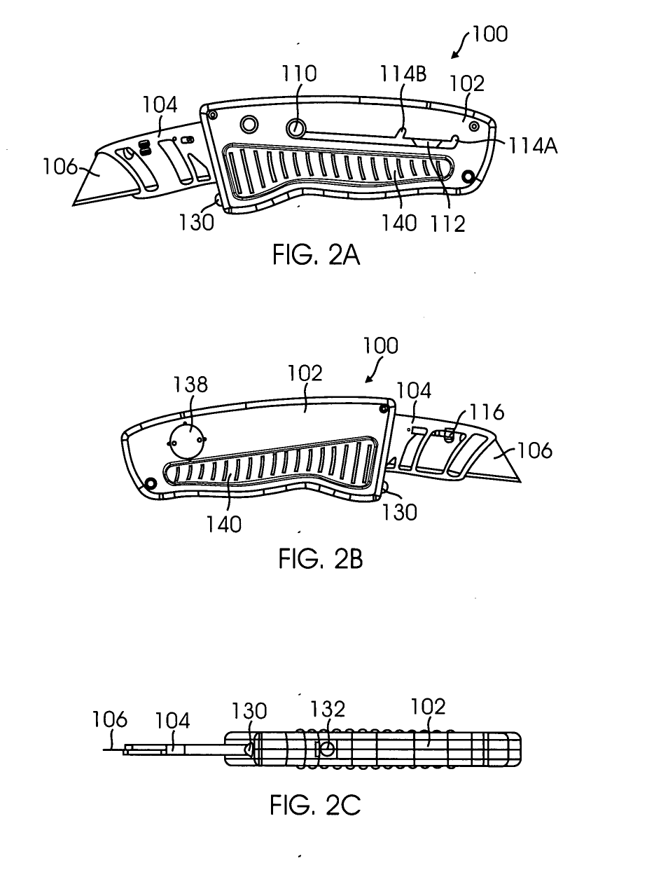

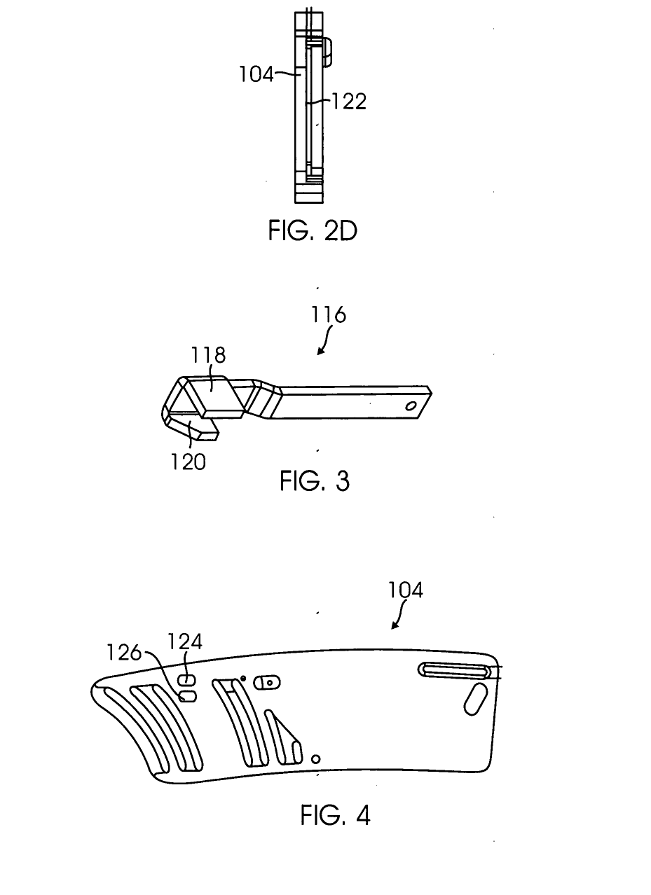

FIG. 1 is an exploded view of a utility knife 100 according to one embodiment of the present invention, and FIGS. 2A-2D are a side view, another side view, a bottom view, and an end view of utility knife 100. Utility knife includes a handle or body 102, a knife blade holder or carrier 104, and a knife blade 106. Blade carrier 104 is attached to a slide mechanism 108 on the side of body 102 to enable the blade holder to be moved in and out of the body. Slide mechanism includes a thumb or finger control button 110 attached via opening 109, such that button 110 is slidable along a lengthwise opening 112 of the body. Button 110 is shown as a round element, but other shapes are likewise suitable. Button 110 also has a rubber top surface and a knurled circumference for ease of operation, i.e., less slippage when moving slide mechanism 108.

Opening 112 has three slots 114A-114C, which enables the user to lock blade holder 104 in one of three positions. Note that opening 112 can have two or more slots, depending on how many locking positions are desired. When button 110 is placed in slot 114A, blade carrier 104 and blade 106 are fully retracted into body 102. When button 110 is placed in slot 114B, blade carrier 104 is mostly in body 102, but blade 106 is outside body 102 and available for use. When button 110 is in slot 114C, blade carrier 104 and blade 106 are fully extended. Button 110 is under tension, such as with a semi-rigid metal or spring 111. The tension forces the button against the upper portion of opening 112. As a result, when button 110 is moved to one of slots 114, button 110 moves into a slot and is pressed into the slot. This enables the user to easily position button 110 into a desired slot and prevent button 110 from disengaging from the slot, thereby securing blade carrier 104 and blade 106 in the desired position.

Blade carrier 104 has an opening 122 configured to hold blade 106. Blade carrier 104 also has a release/lock mechanism 116, which allows the user to remove and replace blade 106. In one embodiment, release/lock mechanism 116 comprises a lever or spring having a first prong 118 and a second shorter prong 120. First and second prongs 118 and 120 match up to openings 124 and 126, respectively, in blade carrier 104. When blade 106 is secured within carrier 104, second prong 120 is positioned between one of two slots 128 in blade 106. A second of the slots is used to secure blade 106 when the blade is reversed, i.e., inserted with the other end of the blade. To release blade 106, first prong 118, which protrudes from opening 124, is depressed, resulting in second prong 120 being moved out of slot 128. This then enables the user to pull the blade out of carrier 104. Blade 106 can be inserted by depressing first prong 118 and sliding in the blade until a slot 128 aligns with second prong 120. First prong 118 is then released, thereby moving second prong 120 into the slot and securing the blade.

Utility knife 100 may also include a light or LED 130 located on a bottom portion of the knife. LED 130 is positioned such that light from the LED illuminates an area or work area underneath knife blade 106. This increased visibility aids the user in more accurate and safer cutting. In addition, the light can be used simply as a low-power light, without having the knife blade exposed or in use. A power button 132 on a bottom portion of knife 100 is used to turn LED 130 on and off. By pressing button 132 and keeping it pressed down, LED 130 is lit. By releasing button 132, LED 130 turns off. Power is supplied to the LED by a battery 134, such as a lithium battery, enclosed within body 102 by a retainer 136 and cover 138. The location of button 132 makes it easier for the user to operate LED 130. For example, to turn on the LED for cutting, the user simply holds knife in a normal cutting grip and presses down on button 132 with, for example, the index finger. Grips 140 on both sides of body 102 enable the user to more securely hold and use the knife. Grips, which can be a texturized rubber, can also provide increased comfort for the user.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as fall within the true spirit and scope of this invention.

What is claimed is:

1. A utility knife, comprising:
a knife blade;
a blade holder having an opening to hold the knife blade;
a body having a first opening at one end, wherein the blade holder is slidable into and out of the first opening; and
a light within the body and positioned below the knife blade and the blade holder.

2. The knife of claim 1, wherein the light is a light emitting diode.

3. The knife of claim 1, wherein the light is directed in the same direction as the knife blade.

4. The knife of claim 1, wherein the body comprises a power button to turn the light on and off, wherein the power button is located on a bottom portion of the body.

5. The knife of claim 4, wherein the power button is located proximate to a user's index finger when gripping the body.

6. The knife of claim 1, further comprising a slide element attached to the blade holder, and wherein the body further comprises a second opening on one side, wherein the slide element is movable along the second opening to move the blade holder.

7. The knife of claim 6, wherein the second opening comprises at least two slots to secure the blade holder in a fixed position.

8. The knife of claim 7, wherein the second opening comprises three slots.

9. The knife of claim 6, wherein the slide element is biased along an edge of the second opening.

10. The knife of claim 1, further comprising a blade release/retention mechanism having a first prong and a shorter second prong.

11. The knife of claim 10, wherein the blade holder comprises two openings corresponding to the first and second prongs.

12. The knife of claim 11, wherein the blade release/retention mechanism is biased against the two openings.

13. The knife of claim 11, wherein the blade has at least one slot, and wherein the second prong fits within the at least one slot to secure the blade to the blade holder.

14. The knife of claim 13, wherein the first prong protrudes outside one of the openings in a biased position.

15. The knife of claim 14, wherein the second prong moves out of the at least one slot when the first prong is depressed.

16. A utility knife comprising:
a knife blade having at least one slot;
a blade holder having a first opening at one end to hold the knife blade and at least two second openings through a side;
a lever having a first prong and a shorter second prong corresponding to the second openings of the blade holder and biased against the second openings;
a slide element attached to the blade holder;
a body having a first opening at one end, wherein the blade holder is slidable into and out of the first opening, and a second opening on one side, wherein the slide element is movable along the second opening to move the blade holder; and
a light within the body and positioned below the knife blade and the blade holder.

17. The knife of claim 16, wherein the body comprises a power button to turn the light on and off, wherein the power button is located on a bottom portion of the body.

18. The knife of claim 17, wherein the power button is located proximate to a user's index finger when gripping the body.

19. The knife of claim 16, wherein the second opening of the body comprises at least two slots to secure the blade holder in a fixed position.

20. The knife of claim 19, wherein the slide element is biased against the slots and one edge of the second opening of the body.
